(19) United States
(12) Patent Application Publication
(10) Pub. No.: US 2023/0154647 A1
(43) Pub. Date: May 18, 2023

(54) WIRING MEMBER

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Kyousyou KOU, Mie (JP); Housei MIZUNO, Mie (JP); Miyu ARAMAKI, Mie (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 17/916,704

(22) PCT Filed: Mar. 24, 2021
(86) PCT No.: PCT/JP2021/012320

§ 371 Date: Oct. 3, 2022

(30) Foreign Application Priority Data
Apr. 6, 2020 (JP) 2020-068087

(51) Int. Cl. H01B 7/17; H01B 7/00

(52) U.S. Cl. CPC H01B 7/17; H01B 7/0045

(57) ABSTRACT

A wiring member includes a wire-like transmission member including a transmission wire body and a covering layer covering the transmission wire body; a first sheet including a first fusion layer having contact with the wire-like transmission member and provided on one side of the wire-like transmission member; and a second sheet including a second fusion layer having contact with the wire-like transmission member and provided on another side of the wire-like transmission member. The covering layer is fused to each of the first fusion layer and the second fusion layer.

### TECHNICAL FIELD

The present disclosure relates to a wiring member.

### BACKGROUND ART

Patent Document 1 discloses a wire harness in which un electrical wire is welded to a functional exterior member formed into u sheet-like shape.

### PRIOR ART DOCUMENTS

### Patent Document(s)

Patent Document 1: Japanese Patent Application Laid-Open No. 2018-137208

### SUMMARY

### Problem to be Solved by the Invention

It is desired that both sides of an electrical wire can be simply protected

An object is to provide a technique capable of simply protecting both sides of a wire-like transmission member

### Means to Solve the Problem

A wiring member according to the present disclosure includes: a wire-like transmission member including a transmission wire body and a cowing layer covering the transmission wire body: a first sheet including a first fusion layer having contact with the wire-like transmission member und provided on one side of the wire-like transmission member, and a second sheet including a second fusion layer having contact with the wire-like transmission member and provided on another side of the wire-like transmission member, wherein the covering layer is fused to each of the first fusion layer and the second fusion layer.

### Effects of the Invention

According to the present disclosure, both sides of the wire-like transmission member can be simply protected.

### BRIEF DESCRIPTION OF DRAWINGS

FIG. 1 is a plan view illustrating a wiring member according to an embodiment 1.

FIG. 2 is a cross-sectional view of the wiring member cut along a II-II line in FIG. 1.

FIG. 3 is a plan view illustrating a wiring member according to an embodiment 2.

FIG. 4 is a plan view illustrating a wiring member according to an embodiment 3.

FIG. 5 is a cross-sectional view illustrating a wiring member according to an embodiment 4.

FIG. 6 is a cross-sectional view illustrating a wiring member according to an embodiment 5.

### DESCRIPTION OF EMBODIMENT(S)

### Description of Embodiment of Present Disclosure

Embodiments of the present disclosure are listed and described firstly.

A wiring member according to the present disclosure is as follows.

(1) A wiring member includes: a wire-like transmission member including a transmission wire body and a covering layer covering the transmission wire body; a first sheet including a first fusion layer having contact with the wire-like transmission member and provided on one side of the wire-like transmission member; and a second sheet including a second fusion layer having contact with the wire-like transmission member and provided on another side of the wire-like transmission member, wherein the covering layer is fused to each of the first fusion layer and the second fusion layer. The covering layer is fused to each of the first sheet and the second sheet, thus the first sheet and the second sheet are simply fixed to both sides of the wire-like transmission member. Accordingly, both sides of the wire-like transmission member we simply protected by the first sheet and the second sheet.

(2) In the wiring member according to (1), the first fusion layer and the second fusion layer may be fused to each other on a lateral side of the wire-like transmission member. Accordingly, exposure of the wire-like transmission member from between the first sheet and the second sheet can be suppressed.

(3) In the wiring member according to (1), the first fusion layer and the second fusion layer may not be fused to each other on u lateral side of the wire-like transmission member. Accordingly, tire wiring member can be easily manufactured. A fusion space for fusing the first sheet and the second sheet needs not be provided on the lateral side of the wire-like transmission member, thus a width dimension of the wiring member can be reduced.

(4) In the wiring member according to any one of (1) to (3), it is also applicable that the second sheet is provided on a whole surface of the first sheet, and the covering layer is intermittently fused to the first fusion layer and the second fusion layer along tut extension direction of the wire-like transmission member. Accordingly, a fusion position can be reduced whole protecting both sides of the wire-like transmission member in a wide region.

(5) In the wiring member according to any one of (1) to (3), the second sheet may be partially provided on the first sheet. Accordingly, increase in weight of the wiring member can be suppressed by providing the second sheet in a necessary portion.

(6) In the wiring member according to any one of (1) to (5), it is also applicable that the first sheet and the second sheet are provided in a region including an intersection part of the wire-like transmission member, the covering layer is not fused to the first fusion layer and the second fusion layer in the intersection part, and the covering layer is fused to the first fusion layer and the second fusion layer in a position away from the intersection part. Accordingly, deformation of the wire-like transmission member in the intersection part is suppressed.

(7) In the wiring member according to any one of (1) to (6), another wire-like transmission member may be fused to a surface of the second sheet on a side opposite to a surface of the second sheet facing the wire-like transmission member. Accordingly, the wire-like transmission member is provided to have multiple layers.

### Details of Embodiment of Present Disclosure

Specific examples of a wiring member of the present disclosure are described hereinafter with reference to the drawings. The present disclosure is not limited to these examples, but is indicated by claims, and it is intended that meanings equivalent to claims and all modifications within a scope of claims are included.

### Embodiment 1

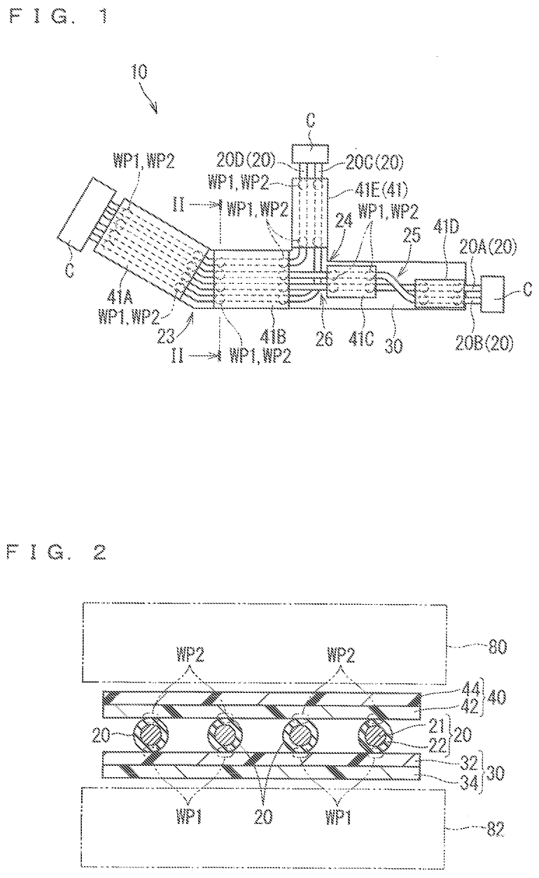

A wiring member according to an embodiment 1 is described hereinafter. FIG. 1 is a plan view illustrating the wiring member 10 according to the embodiment 1. FIG. 2 is a cross-sectional view of the wiring member 10 cut along a II-II line in FIG. 1.

The wiring member 10 includes a wire-like transmission member 20, a first sheet 30, and a second sheet 40.

The wire-like transmission member 20 is a wire-like member transmitting electrical power or light, for example. For example, the wire-like transmission member 20 may be a general wire having a core wire and a covering around the core wire, or may also be a shielded wire, an electrical cable, an enamel wire, a nichrome wire, or an optical fiber cable. The wire-like transmission member 20 includes a transmission wire body 21 and a covering layer 22. The transmission wire body 21 is a portion transmitting electrical power or light. The transmission wire body 21 corresponds to a conductor core wire in the electrical wire, and corresponds to a core and a clad in an optical fiber cable. The covering layer 22 covers the transmission wire body 21. The covering layer 22 is formed of a resin material extruded around the transmission wire body 21 to cover it, for example. A type of the resin material is not particularly limited, but polyvinyl chloride (PVC), polyethylene (PE), polypropylene (PP), or polyethylene terephthalate (PET) can be adopted, tor example.

The wire-like transmission member 20 transmitting the electrical power may be various kinds of signal lines or various kinds of power lines. Some of the wire-like transmission members 20 transmitting the electrical power may be used as an antenna or coil, for example, transmitting or receiving a signal or electrical power to or from a space The wire-like transmission member 20 may be a single wire-like object or a composite object of a plurality of wire-like objects (a twisted wire and a cable made up of u plurality of wire-like objects covered by a sheath). When the wire-like transmission member 20 is a cable, a sheath is also included in the covering layer 22.

It is sufficient that the number of the wire-like transmission members 20 is at least one, thus one or the plurality of wire-like transmission members 20 are also applicable. Herein, four wire-like transmission members 20 are included. When the four wire-like transmission members 20 need to be distinguished, they are referred to as the wire-like transmission members 20A, 20D, 20C, and 20D in some cases.

The plurality of wire-like transmission members 20 are assumed to be members connecting components in a vehicle. An end portion of the wire-like transmission member 20 extends from the sheets 30 and 40 to be located on an outer side of the sheets 30 and 40. An intermediate portion of the wire-like transmission member 20 except for the end portion is disposed on the sheets 30 and 40. A connector C, for example, is provided on an end portion of the wire-like transmission member 20. This connector C is connected to a connector provided in the other side component, thus the wire-like transmission member 20 is connected to the other side component. That is to say, the present wiring member 10 is used as the wiring member 10 electrically connecting various types of component in a vehicle, for example (or connecting them so that they can perform optical communication). The end portion of the wire-like transmission member 20 may also be located on the sheets 30 and 40. The connector C may be fixed to the sheets 30 and 40.

The first sheet 30 is provided on one side of the wire-like transmission member 20. The first sheet 30 includes a first fusion layer 32. The first fusion layer 32 has contact with the wire-like transmission member 20. The first fusion layer 32 is fused to the covering layer 22 on an outermost side of the wire-like transmission member 20.

Herein, the first sheet 30 has a double layer structure of the first fusion layer 32 and a first additional layer 34. The first sheet 30 may include a single layer structure made up of the first fusion layer 32 or a structure made up of three or more layers.

One surface of the first fusion layer 32 is a surface having contact with the wire-like transmission member 20. The first fusion layer 32 includes a resin material, or preferably includes a thermoplastic resin material. The resin material of the first fusion layer 32 is softened and fused to a fusion target. A type of the resin material is not particularly limited, however, PVC, PE, PP, and PET, for example, can be adopted. The resin material of the first fusion layer 32 is preferably the same as the resin material of the covering layer 22.

A structure of the first fusion layer 32 is not particularly limited. For example, the first fusion layer 32 may be a sheet having an evenly filled cross-sectional surface (also referred to as a non-foam sheet or a solid sheet, for example). For example, the first fusion layer 32 is also considered a foam sheet, for example. The first fusion layer 32 is also considered a fibrous material sheet such as a braided cloth, a woven cloth, or a non-woven cloth, for example.

The first additional layer 34 is formed of a material different from that of the first fusion layer 32, or has a different structure. The first additional layer 34 increases a function of the first fusion layer 32 or adds a function which the first fusion layer 32 does not have to the first sheet 30. A material constituting the first additional layer 34 may be a material described for the first fusion layer 32 described above or metal, for example. A structure of the first additional layer 34 may be any of the structure described for the first fusion layer 32 described above. One surface of the first additional layer 34 is an outward main surface of the first sheet 30 directed to a side opposite to the wire like transmission member 20.

The first fusion laser 32 and the first additional layer 34 are fixed to each other while the other surface of the first fusion layer 32 end the other surface of the first additional layer 34 have contact with each other. A fixing stale of the first fusion layer 32 and the first additional layer 34 is not particularly limited, however, fixing by fusion or adhesion is preferable. For example, when at least one of the first fusion layer 32 and/or the first additional layer 34 is a sheet having voids in a surface such as a fibrous material sheet or a foam sheet, a resin material or an adhesive agent enters the voids and the layers can be fixed to each other. Such a configuration causes so-called anchor effect, thus the first fusion layer 32 and the first additional layer 34 are rigidly fixed.

In the description herein, the first fusion layer 32 is a solid sheet formed of resin and the first additional layer 34 is a fibrous material sheet. In the description herein, the first fusion layer 32 and the first additional layer 34 are fused to each other. That is to say, the resin of the first fusion layer 32 enters between the fibers of the first additional layer 34 while having followability, and is then hardened. Accordingly, a state where the resin of the first fusion layer 32 enters between the fibers of the first additional layer 34 is maintained, and the first fusion layer 32 and the first additional layer 34 are rigidly fixed.

The first fusion layer 32 and the first additional layer 34 are formed to have the same size (the same planar shape). One of the first fusion layer 32 and the first additional layer 34 may also be formed to be larger than the other one thereof. The first fusion layer 32 and the first additional layer 34 are wholly fixed at a region where they have contact with each other. The first fusion layer 32 and the first additional layer 34 may also be fixed only at a part of a region where they have contact with each other.

The first sheet 30 may be a flexible member. For example, the first fusion layer 32 is a resin layer having an evenly filled cross-sectional surface made up of flexible resin such as flexible PVC, as a material, the first additional layer 34 is a non-woven cloth made up of PET as a material, and the first sheet 30 is a flexible member. For example, the first sheet 30 may have a plastic property so as to be able to follow bending of the wire-like transmission member 20. It is also applicable that the wiring member 10 can be bended in a thickness direction (bending so that a fold line follows a main surface of the first sheet 30) in a portion where the first sheet 30 is provided. The first sheet 30 may be a member which cannot be curved in the thickness direction. The first sheet 30 may be a member which is not broken but can be bended at a time of being bended in the thickness direction. The first sheet 30 may be a member which cannot be bended but is broken at a time of being bended in the thickness direction. The first sheet 30 may have rigidness so that it cannot follow bending of the wire-like transmission member 20,

The second sheet 40 is provided on the other side of the wire-like transmission member 20. The second sheet 40 includes a second fusion layer 42. The second fusion layer 42 has contact with the wire-like transmission member 20. The second fusion layer 42 is fused to the covering layer 22 on an outermost side of the wire-like transmission member 20.

Herein, the same type of sheet material as that of the sheet material constituting the first sheet 30 is adopted as a sheet material constituting the second sheet 40. The second sheet 40 has a double layer structure of the second fusion layer 42 and a second additional layer 44. The second fusion layer 42 is a layer having the same material and structure as the first fusion layer 32. The second additional layer 44 is a layer having the same material and structure as the first additional layer 34. The sheet material constituting the second sheet 40 may be a different type of sheet material as that constituting the first sheet 30. The second sheet 40 may include a single layer structure made up of the second fusion layer 42 or a structure made up of three or more layers

The first sheet 30 and the second sheet 40 keep the plurality of wire-like transmission members 20 in a state of being arranged side by side. The wiring member 10 is thereby flatly formed. The first sheet 30 and the second sheet 40 keep the wire-like transmission member 20 in a state of extending along a predetermined route. A route of the wire-like transmission member 20 is a route along which the wire-like transmission member 20 extends on an assembly target (for example, a vehicle) when the wiring member 10 is assembled to the assembly target. Accordingly, when the wiring member 10 is assembled to a vehicle, for example, the wire-like transmission member 20 is easily kept in a state of following a predetermined route in the vehicle.

Herein, a route of the wire-like transmission member 20 includes a bending part 23 and a branch part 24. The bending part 23 is a portion where the plurality of wire-like -transmission members 20A, 20B, 20C, and 20D are bended while being in parallel to each other. The branch part 24 is a portion where some wire-like transmission members 20A and 20B are branched to extend in a direction different from the other some wire-like transmission members 20C and 20D.

Intersection parts 25 and 26 where the plurality of wire-like transmission member 20 intersect with each other are provided. Herein, the intersection parts 25 and 26 include a displacement intersection part 25 and a branch intersection part 26. The displacement intersection part 25 is a portion where the wire-like transmission members 20A and 20B parallelly arranged intersect with each other to change their arrangement order. The branch intersection part 26 is a portion where some wire-like transmission member 20C is branched from the other some wire-like transmission members 20A and 20B.

Herein, the first sheet 30 is formed into a shape following a route of the wire-like transmission member 20. Specifically, the first sheet 30 includes a portion bended in accordance with the bending part 23 of the wire-like transmission member 20. The first sheet 30 includes a portion branched in accordance with a branched route of the wire-like transmission member 20. The first sheet 30 may be formed into one large rectangular shape, for example.

Herein, a planar shape of the second sheet 40 is different from that of the first sheet 30. The second sheet 40 is partially provided on the first sheet 30. Specifically, herein, the second sheet 40 includes a plurality of sheet parts 41. Each of the plurality of sheet parts 41 are provided to cover a planar region different from each other on the first sheet 30. The plurality of sheet parts 41 are provided at intervals. In the example illustrated in FIG. 1, five sheet parts 41A, 41B, 41C, 41D, and 41E are provided. Each sheet part 41 is provided in a straight part. The sheet part 41 is provided away from the bending part 23. The sheet part 41 is not provided in bending part 23. The sheet part 41 is provided away from the intersection parts 25 and 26. The sheet part 41 is not provided in the intersection parts 25 and 26.

The sheet parts 41A and 41B are provided in positions on both sides of the bending part 23. The sheet parts 41C and 41D are provided in positions on both sides of the displacement intersection part 25. The sheet parts 41B, 41C, and 41E are provided in position sandwiching the branch part 24.

The covering layer 22 is fused to the first fusion layer 32 and the second fusion layer 42. The covering layer 22, the first fusion layer 32, and the second fusion layer 42 are intermittently fused along the extension direction of the wire-like transmission member 20. In FIG. 1 and FIG. 2, a portion where the covering layer 22 and the first fusion laser 32 are fused is illustrated as a fusion part WP1 and a portion where the covering layer 22 and the second fusion layer 42 are fused is illustrated as a fusion part WP2. The fusion part WP1 and the fusion part WP2 are located in the same position along the extension direction of the wire like transmission member 20. The wire-like transmission member 20 is fused to the second fusion laser 42 on a side opposite to a side thereof fused to the first fusion layer 32. The fusion parts WP1 and WP2 are provided in positions in ends of the sheet pons 41, respectively.

A means of forming the fusion state is not particularly limited. For example, the wire-like transmission member 20, the first sheet 30, and the second sheet 40 may be fused to each other by ultrasonic fusion. Resin, for example, is melted by friction heat caused by the ultrasonic vibration applied from a horn 80 to a work while the horn 80 and an anvil 82 in an ultrasonic fusion machine sandwich the work, and thus the wire-like transmission member 20, the first sheet 30, and the second sheet 40 are fused. Adoptable are various types of fusion means such as heating pressurizing fusion, hot air fusion, and high frequency fusion. When the fusion state is formed by these means, the wire-like transmission member 20, the first sheet 30, and the second sheet 40 are in a state of fusion fixation by those means. Specifically, when the wire-like transmission member 20, the first sheet 30, and the second sheet 40 are fused by ultrasonic fusion, the fusion parts WP1 and WP2 are ultrasonic fusion parts, few example.

The first fusion layer 32 and the second fusion layer 42 are not fused on a lateral side of the wire-like transmission member 20. The lateral side of the wire-like transmission member 20 is a portion of the plurality of wire-like transmission members 20 located on an outer side of two wire-like transmission members 20, which are located on an outermost side along a parallel direction, along a parallel direction. The first fusion layer 32 and the second fusion layer 42 do not have contact with each other on the lateral side of the wire-like transmission member 20.

Herein, the plurality of wire-like transmission members 20 are provided at intervals along the parallel direction. The plurality of wire-like transmission members 20 may also be parallelly arranged while having contact with each other without intervals therebetween along the parallel direction.

The first fusion layer 32 and the second fusion layer 42 are not fused between the wire-like transmission members 20. The first fusion layer 32 and the second fusion layer 42 do not have contact with each other between the wire-like transmission members 20. The first fusion layer 32 and the second fusion layer 42 may have contact with each other between the wire-like transmission members 20. The first fusion layer 32 and the second fusion layer 42 may be fused to each other between the wire-like transmission members 20.

### Effect Etc. of Embodiment 1

According to the wiring member 10 having the above configuration, the covering layer 22 is fused to each of the first sheet 30 and the second sheet 40, thus the first sheet 30 and the second sheet 40 are simply fixed to both sides of the wire-like transmission member 20. Accordingly, both sides of the wire-like transmission member 20 are simply protected by the first sheet 30 and the second sheet 40.

The first fusion layer 32 and the second fusion layer 42 are not fused on the lateral side of the wire-like transmission member 20. Accordingly, the wiring member 10 can be easily manufactured. A fusion space for fusing the first sheet 30 and the second sheet 40 needs not be provided on the lateral side of the wire-like transmission member 20, thus a width dimension of the wiring member 10 can be reduced.

The second sheet 40 is partially provided on the first sheet 30. Accordingly, increase in weight of the wiring member 10 can be suppressed by providing the second sheet 40 in a necessary portion.

### Embodiment 2

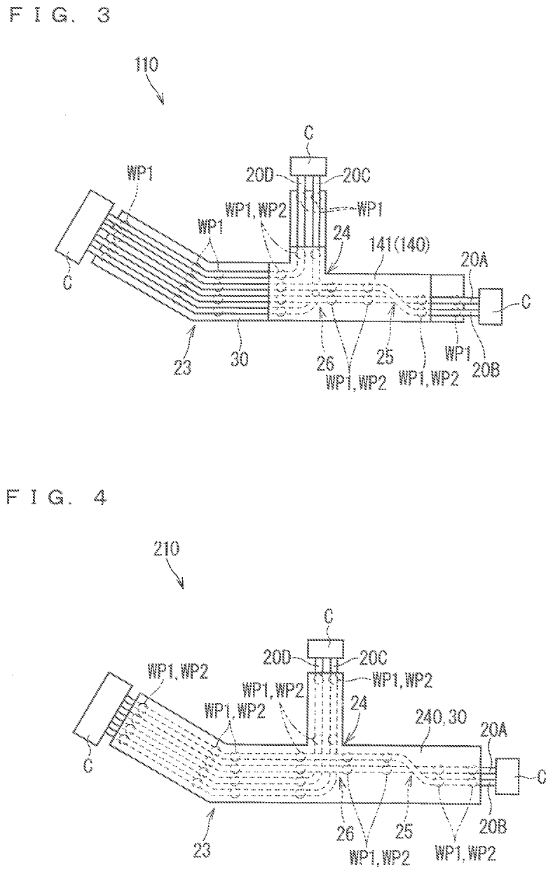

A wiring member according to an embodiment 2 is described. FIG. 3 is a plan view illustrating a wiring member 110 according to the embodiment 2. In the following description, the same reference numerals are assigned to the similar constituent elements described above, and the description thereof will be omitted.

A portion where a second sheet 140 is provided in the wiring member 110 according to the present example is different from a portion where the second sheet 40 is provided in the wiring member 10 described above. The second sheet 140 includes one sheet part 141. The sheet part 141 is provided in a region including the intersection parts 25 and 26. Thus the first sheet 30 and the second sheet 140 are provided in a region including the intersection parts 25 and 26 of the wire-like transmission member 20.

The covering layer 22 is not fused to the first fusion layer 32 and the second fusion layer 42 in the displacement intersection part 25. The covering layer 22 is fused to the first fusion layer 32 and the second fusion layer 42 in a position away from the displacement intersection part 25. The covering layer 22 is not fused to the first fusion layer 32 and the second fusion layer 42 in the branch intersection pan 26. The covering layer 22 is fused to the first fusion layer 32 and the second fusion layer 42 in a position away from the branch intersection part 26. Accordingly, the covering layer 22 is not fused to the first fusion layer 32 and the second fusion layer 42 in the intersection parts 25 and 26. The covering layer 22 is fused to the first fusion layer 32 and the second fusion layer 42 in a position away from the intersection puts 25 and 26. Accordingly, deformation of the wire-like transmission member 20 in the intersection parts 25 and 26 is suppressed.

In the wiring member 110, the fusion part WP1 is provided in a region where the first sheet 30 is provided but the second sheet 40 is not provided. A position of the fusion port WP1 in the wiring member 110 is the same as that of the fusion part WP1 in the wiring member 10.

### Embodiment 3

A wiring member according to an embodiment 3 is described. FIG. 4 is a plan view illustrating a wiring member 210 according to the embodiment 3.

A planar shape of a second sheet 240 in the wiring member 210 according to the present example is different from that of the second sheets 40 and 140 in the wiring members 10 and 110 described above. Herein, the second sheet 240 is wholly provided on the first sheet 30. The first sheet 30 and the second sheet 240 have the same planar shape. At this time, the covering layer 22 is intermittently fused to the first fusion layer 32 and the second fusion layer 42 along the extension direction of the wire-like transmission member 20. Accordingly, a fusion position can be reduced whole protecting both sides of the wire-like transmission member 20 in a wide region.

Herein, the first sheet 30 and the second sheet 240 are provided in a region including the bending part 23 of the wire-like transmission member 20. The covering layer 22 is not fused to the first fusion layer 32 and the second fusion layer 42 in the bending part 23. The covering layer 22 is fused to the first fusion layer 32 and the second fusion layer 42 in a position away from the bending part 23. The covering layer 22 is fused to the first fusion layer 32 and the second fusion layer 42 in positions on both sides of the bending part 23.

Positions of the fusion parts WP1 and WP2 in the wiring member 210 are the same as those in the wiring member 10. Also in the present example, the fusion parts WP1 and WP2 are not provided in the intersection parts 25 and 26, and the fusion parts WP1 and WP2 are provided in position away from the intersection parts 25 and 26 (end portions of a straight part herein).

### Embodiment 4

A wiring member according to an embodiment 4 is described. FIG. 5 is a cross-sectional plan view illustrating a wiring member 310 according to the embodiment 4.

The wiring member 310 according to the present example is different from the wiring members 10, 110, and 210 in that the first sheet 330 and the second sheet 340 are fused to each other. Each of the first sheet 330 and the second sheet 340 has a portion protruding to a lateral side of the wire-like transmission member 20. This protruding part serves as the fusion space. The first fusion layer 32 and the second fusion layer 42 in the fusion space are fused on the lateral side of the wire-like transmission member 20. A fusion part WP3 of the first fusion layer 32 and the second fusion layer 42 is provided on a lateral side of the wire-like transmission member 20. Accordingly, exposure of the wire-like transmission member 20 from between the first sheet 330 and the second sheet 340 can be suppressed. In FIG. 5, the fusion part WP3 is provided on both lateral sides of the wire-like transmission member 20. The fusion part WP3 may be provided on only one lateral side of the wire-like transmission member 20.

The fusion part WP3 may be sequentially provided over a whole region along the extension direction of the wire-like transmission member 20. The fusion part WP3 may be intermittently provided along the extension direction of the wire-like transmission member 20 in the manner similar to the fusion parts WP1 and WP2. In this case, the fusion part WP3 may be provided in the same position as the fusion parts WP1 and WP2, or may also be provided in a different position.

The first sheet 330 and the second sheet 340 are not fused to each other between the wire-like transmission members 20. The first sheet 330 and the second sheet 340 may be fused to each other between the wire-like transmission members 20.

### Embodiment 5

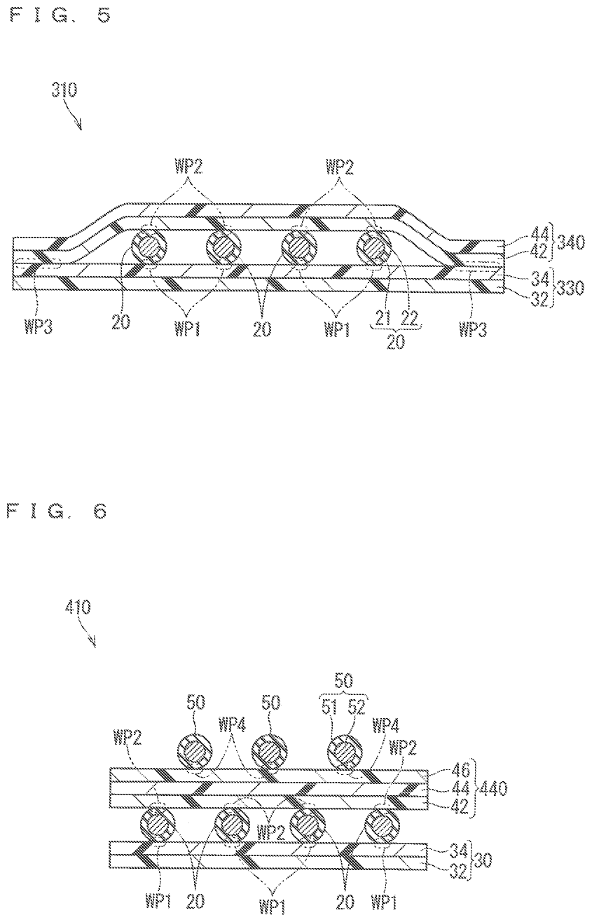

A wiring member according to an embodiment 5 is described. FIG. 6 is a cross-sectional plan view illustrating a wiring member 410 according to the embodiment

The wiring member 410 according to the present example is different from the wiring members 10, 110, 210, and 310 described above in that the wiring member 410 further includes the other wire-like transmission member 50.

The other wire-like transmission member 50 is fused to a surface of the second sheet 440 on a side opposite to a surface thereof facing the wire-like transmission member 20. Accordingly, the wire-like transmission members 20 and 50 are provided to have multiple layers. Specifically, the other wire-like transmission member 50 includes a transmission wire body 51 and a covering layer 52 in the manner similar to the wire-like transmission member 20. The fusion layer is provided on a surface of the second sheet 440 having contact with the other wire-like transmission member 50. In the example illustrated in FIG. 6, the second sheet 440 has a triple layer structure of the second fusion layer 42, the second additional layer 44, and a third fusion layer 46. The covering layer 52 of the other ire-like transmission member 50 is fixed to the third fusion layer 46. It is applicable that the second sheet 440 has a single layer structure made up of the second fusion layer 42, and the wire-like transmission members 20 and 50 may be fused to both surfaces of the second fusion layer 42.

The second sheet 440 may cover a part of the first sheet 30 in the manner similar to the second sheets 40 and 140, or may also cover a whole surface of the first sheet 30 in the manner similar to the second sheet 240 described above.

In the example illustrated in FIG. 6, the other wire-like transmission member 50 is located between the wire-like transmission members 20 or a lateral side of the wire-like transmission member 20 so as not to be overlapped with the wire-like transmission member 20. The fusion part WP4 of the covering layer 52 of the other wire-like transmission member 50 and the third fusion layer 46 deviates in a parallel direction of the fusion parts WP1 and WP2 and the wire-like transmission member 20. The other wire-like transmission number 50 may be located to be overlapped with the wire-like transmission member 20. The fusion part WP4 may be located in the same position along the parallel direction of the fusion parts WP1 and WP2 and the wire-like transmission member 20.

The number of the other wire-like transmission members 50 is smaller than that of the wire-like transmission members 20. The number of the wire-like transmission members 50 may be equal to or larger than that of the wire-like transmission members 20.

A route of the wire-like transmission member 20 and a route of the other wire-like transmission member 50 can be appropriately set. The other wire-like transmission member 50 may also extend along the same route as the wire-like transmission member 20. The other wire-like transmission member 50 may also extend along a route different from that of the wire-like transmission member 20. For example, it is also applicable that the other wire-like transmission member 50 extends along the same route as the wire-like transmission member 20 in a part of a section, and extends along a route different from that of the wire-like transmission member 20 in the other part of the section. The wire-like transmission member 20 and the other wire-like transmission member 50 may be fused to the second sheet 440 at least in a section extending along the same route.

One end portion and the other end portion of the other wire-like transmission member 50 may be connected to the same connector C as that to which one end portion und the other end portion of the wire-like transmission member 20 are connected. One end portion and the other end portion of the other wire-like transmission member 50 may be connected to a connector C different from that to which one end portion and the other end portion of the wire-like transmission member 20 are connected. It is also applicable that one end portion of the oilier wire-like transmission member 50 is connected the same connector C us that to which one end portion of the wire-like transmission member 20 is connected, and the other end portion of the other wire-like transmission member 50 is connected to a connector different from that to which the other end portion of the wire-like transmission member 20 is connected.

In the example illustrated in FIG. 6, the other wire-like transmission member 50 on a side opposite to the second sheet 440 is exposed. The third sheet covering the other wire-like transmission member 50 from a side opposite to the second sheet 440 may be provided. The third sheet may be fused to the other wire-like transmission member 50.

### Modification Example

In the above description, the fusion parts WP1 and WP2 are intermittently provided along the extension direction of the wire-like transmission member 20, however, this configuration is not necessary. The fusion parts WP1 and WP2 may be sequentially provided over a whole region along the extension direction of the wire-like transmission member 20.

The plurality of wiring members 10 may be connected to a lateral side to constitute a wiring module. For example, the first sheets 30 or the second sheets 40 of the plurality of wiring members 10 may be fused to each other. A type of the wire-like transmission men her may be different between one wiring member and the other one wiring member in the plurality of wiring members connected to each other. For example, it is also applicable that a plurality of thin wire-like transmission members are disposed in one wiring member, and a plurality of thick wire-like transmission members are disposed in the other one wiring member. Accordingly, the thickness of the wire-like transmission member is uniformed in each wiring member, thus the first fusion layer 32 and the second fusion layer 42 can have favorably contact with the wire-like transmission member. For example, it is also applicable that a wire-like transmission member having a covering layer made of PVC is disposed in one wiring member, and a wire-like transmission member having a covering layer made of polyolefin is disposed in the other one wiring member. Accordingly, a material of the covering layer of the wire-like transmission member is uniformed in each wiring member. The first fusion layer 32 and the second fusion layer 42 are formed by materials in accordance with the covering layer in each wiring member, thus can be favorably fused to the wire-like transmission member.

The configurations described in the embodiments and modification examples thereof can be appropriately combined as long as they are not contradictory.

### EXPLANATION OF REFERENCE SIGNS

10, 110, 210, 310, 410 wiring member

20, 20A, 20B, 20C, 20D, 50 wire-like transmission member

21,51 transmission wire body

22, 52 covering layer

23 bending part

24 branch part

25 displacement intersection part

26 branch intersection part

30, 330 first sheet

32 first fusion layer

34 first additional layer

40, 140, 240, 340, 440 second shed

41, 41A, 41B, 41C, 41D, 41E, 141 sheet part

42 second fusion layer

44 second additional layer

46 third fusion layer

80 horn

82 anvil

WP1, WP2, WP3, WP4 fusion part

1. A wiring member, comprising:
a wire-like transmission member including a transmission wire body and a covering layer covering the transmission wire body;
a first sheet including a first fusion layer having contact with the wire-like transmission member and provided on one side of the wire-like transmission member; and
a second sheet including a second fusion layer having contact with the wire-like transmission member and provided on another side of the wire-like transmission member, wherein
the covering layer is fused to each of the first fusion layer and the second fusion layer.

2. The wiring member according to claim 1, wherein
the first fusion layer and the second fusion layer are fused to each other on a lateral side of the wire-like transmission member.

3. The wiring member according to claim 1, wherein
the first fusion layer and the second fusion layer are not be fused to each other on a lateral side of the wire-like transmission member.

4. The wiring member according to claim 1, wherein
the second sheet is provided on a whole surface of the first sheet, and
the covering layer is intermittently fused to the first fusion layer and the second fusion layer along an extension direction of the wire-like transmission member.

5. The wiring member according to claim 1, wherein
the second sheet is partially provided on the first sheet.

6. The wiring member according to claim 1, wherein
the first sheet and the second sheet are provided in a region including an intersection part of the wire-like transmission member,
the covering layer is not fused to the first fusion layer and the second fusion layer in the intersection part, and
the covering layer is fused to the first fusion layer and the second fusion layer in a position away from the intersection part.

7. The wiring member according to claim 1, wherein
another wire-like transmission member is fused to a surface of the second sheet on a side opposite to a surface of the second sheet facing the wire-like transmission member.
